(19) United States
(12) Patent Application Publication
(10) Pub. No.: US 2019/0325416 A1
(43) Pub. Date: Oct. 24, 2019

(54) POS COMMUNICATION DEVICE AND METHOD

(71) Applicants: Adekunle Lekan Iwalesin, Ajax (CA); Jasmine M. St. Rose, Ajax (CA)

(72) Inventors: Adekunle Lekan Iwalesin, Ajax (CA); Jasmine M. St. Rose, Ajax (CA)

(21) Appl. No.: 15/957,747

(22) Filed: Apr. 19, 2018

(51) Int. Cl. G06Q 20/20; G06Q 20/24; G06Q 20/26

(52) U.S. Cl. CPC G06Q 20/206; G06Q 20/26; G06Q 20/24; G06Q 20/202

(57) ABSTRACT

A POS communication device including: a housing, a screen (display means), a fingerprint scanner, at least one inputter, a microprocessor, a receiver, a transceiver, and a powerer; wherein the housing is handheld and provides a mount for the screen, the fingerprint scanner, the at least one inputter, the microprocessor, the receiver, the transceiver, and the powerer. The screen, the fingerprint scanner, the inputter, the receiver, and the transceiver are in communication with the microprocessor being powered by the powerer. The POS communication device is able to be manipulated by an authorized-user to access financial information remotely.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electronic communication means of existing art and more specifically relates to communication devices for use in financial matters.

### RELATED ART

A bank is a financial institution that accepts deposits from the public and creates credit. Credit card companies also offer credit to customers. Lending activities can be performed either directly or indirectly through capital markets. Due to their importance in the financial stability of a country, banks are highly regulated in most countries. Most nations have institutionalized a system known as fractional reserve banking under which banks hold liquid assets equal to only a portion of their current liabilities. Customers can deposit money or withdraw money as desired if available. Modernly, there is a high level of security in banking to keep up with technological advances in accessing accounts to provide convenience. A desirable solution promoting a secure and convenient means to readily access and track accounts is desirable.

Chinese. Pat. No. CN206684419 to Peng Guoyou relates to a POS machine one kind of liquid crystal display module. The described POS machine includes a POS machine module comprising a backlight and a front frame plate, the bottom plate is provided with a backlit liquid crystal display control board, and the bottom side close to the backlight of the main control board is provided with a backlight module, the backlight upper plate is provided with a diffusion plate provided with a plastic frame disposed above the top of the diffusion plate has a diffusion sheet, a diffusion sheet over the plastic frame is provided with a vertical polarizer, the vertically polarized the top sheet is provided with a printed circuit board. The present invention is scientific and rational structure, safe and convenient to use, provided the primary and secondary high abrasion resistant transparent glass and two liquid crystal modules, solving the problem of damage to the module when not working operation, two modules can work separately, when a corrupted, the other still work, easy to use, cannot be used to avoid the problem, set up a fingerprint reader, fingerprint identification cannot be solved, use low security problem that requires fingerprint identification use.

### SUMMARY OF THE INVENTION

In view of the foregoing disadvantages inherent in the known electronic communication means art, the present disclosure provides a novel POS communication device. The general purpose of the present disclosure, which will be described subsequently in greater detail, is to provide a POS communication device which provides real time authorization for financial charges relative to the financial information combined with fingerprint scanning technology via the fingerprint scanner for rapid interactive tracking of the financial charges relating to debit and/or credit.

A POS communication device is disclosed herein; the POS communication device comprising: a housing, a screen (display means), a fingerprint scanner, at least one inputter, a microprocessor, a receiver, a transceiver, and a powerer; wherein the housing is handheld and provides a mount for the screen, the fingerprint scanner, the at least one inputter, the microprocessor, the receiver, the transceiver, and the powerer; the screen, the fingerprint scanner, the inputter, the receiver, and the transceiver are in communication with the microprocessor being powered by the powerer. The POS communication device is able to be manipulated by an authorized-user to access financial information remotely; the receiver, and the transceiver receiving and sending financial-data as pre-authorized by the authorized-user. As designed, the POS communication device provides real time authorization for financial charges relative to the financial information combined with fingerprint scanning technology via the fingerprint scanner for rapid interactive tracking of the financial charges.

In a preferred embodiment, the POS communication device comprises: a housing, a screen, a fingerprint scanner, at least one inputter, a microprocessor, a receiver, a transceiver, at least one USB port, a speaker, and a powerer. In the preferred embodiment the housing is handheld and provides a mount for the screen, the fingerprint scanner, the at least one inputter, the microprocessor, the receiver, the transceiver, a speaker, and the powerer; the screen, the fingerprint scanner, the inputter, the receiver, and the transceiver are in communication with the microprocessor being powered by the powerer. The powerer is able to be charged via a charge cable or other such suitable means.

The POS communication device is able to be manipulated by an authorized-user to access financial information remotely; the receiver, and the transceiver receiving and sending financial-data as pre-authorized by the authorized-user; wherein the financial-data is receivable from at least one financial institution (bank or credit company for example). The fingerprint scanner limits access to a ‘fingerprint-recognized’ authorized-user. The at least one inputter comprises two buttons in preferred embodiments (may be green and red for example). The two buttons are also able to allow access to the authorized-user provided a pre-authorized-code is entered correctly. As such, the authorized-user is able to access at least one debit-account and at least one credit-account. The screen preferably comprises a (interactive) touch-screen; wherein the user is also able to access the data.

The financial-data when sent is received in readable form and in combination with an audible alert delivered via the speaker; wherein the audible alert is delivered upon a transaction-use at a vendor (or bank or credit company or other); the transaction-use is remote from the POS communication device, and as such the transaction-use is able to be authorized and alternately denied in realtime. In this way the authorized-user is able to effectively monitor transactions as they occur. The POS communication device may also be arranged as a kit as disclosed herein.

A method is described herein for using a POS communication device; the method comprising the steps of: providing a POS communication device, the POS communication device comprising: a housing, a screen, a fingerprint scanner, at least one inputter, a microprocessor, a receiver, a transceiver, and a powerer (as previously described); registering a fingerprint of an authorized-user; inputting at least one pre-authorized-code(s) to enable secure communication between the POS communication device and at least one financial (or other) institution and a plurality of user-selected vendors; enabling financial-data alerts to be received when a transaction-use occurs; and remotely monitoring the transaction-use(s) in realtime. The method may further comprise the step of using the POS communication device in combination with a mobile application.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a POS communication device, constructed and operative according to the teachings of the present disclosure.

FIG. 1 is a perspective view of the POS communication device during an ‘in-use’ condition, according to an embodiment of the disclosure.

FIG. 2 is another perspective view of the POS communication device of FIG. 1, according to an embodiment of the present disclosure.

FIG. 3 is a view of the POS communication device of FIG. 1, according to an embodiment of the present disclosure.

FIG. 4 is a view of the POS communication device of FIG. 1, according to an embodiment of the present disclosure.

FIG. 5 is a flow diagram illustrating a method of use for POS communication device, according to an embodiment of the present disclosure.

FIG. 6 shows a screen view of the POS communication device being used to direct a fingerprint to be scanned, according to an embodiment of the present disclosure.

FIG. 7 shows a screen view of the POS communication device once the fingerprint has been scanned, according to an embodiment of the present disclosure.

FIG. 8 shows a screen view of the POS communication device with an option to pay using a credit card, according to an embodiment of the present disclosure.

FIG. 9 shows a screen view of the POS communication device with an option to pay using a debit card, according to an embodiment of the present disclosure.

FIG. 10 shows a screen view of the POS communication device once the preferred method of payment has been selected, according to an embodiment of the present disclosure.

FIG. 11 shows a screen view of the POS communication device displaying a summary of the purchase, according to an embodiment of the present disclosure.

FIG. 12 shows a screen view of the POS communication device displaying a processing message once the user has accepted the payment total, according to an embodiment of the present disclosure.

FIG. 13 shows a screen view of the POS communication device displaying a receipt and options by which the user is able to get a physical or electronic receipt, according to an embodiment of the present disclosure.

FIG. 14 shows another flow diagram for the POS communication device, according to an embodiment of the present disclosure.

FIG. 15 shows a flow diagram for the app used with the POS communication device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an electronic communication means and more particularly to a POS communication device as used to improve the ability of a user to track financial events and occurrences.

Generally, the POS communication device allows users to track and access accounts and account information. The POS communication device allows the user to input a fingerprint reading then access accounts. The software allows access to several debit and credit accounts with the option to use or access whichever account is desired. A touchscreen and input buttons allow the user to select options displayed on the screen. Using the present invention provides that the user is able to get an alert or other notification when items are being purchased (when user is not physically present). This provides that transactions can be accepted or rejected (declined) in realtime. The device may work in conjunction with a banking/credit card application. Registration on the device is effectuated by personal information, banking/credit card information/profile, fingerprint data (being captured) being provided to the software. The user is able to link the merged information as desired with institutions. Passwords or PIN codes may be used.

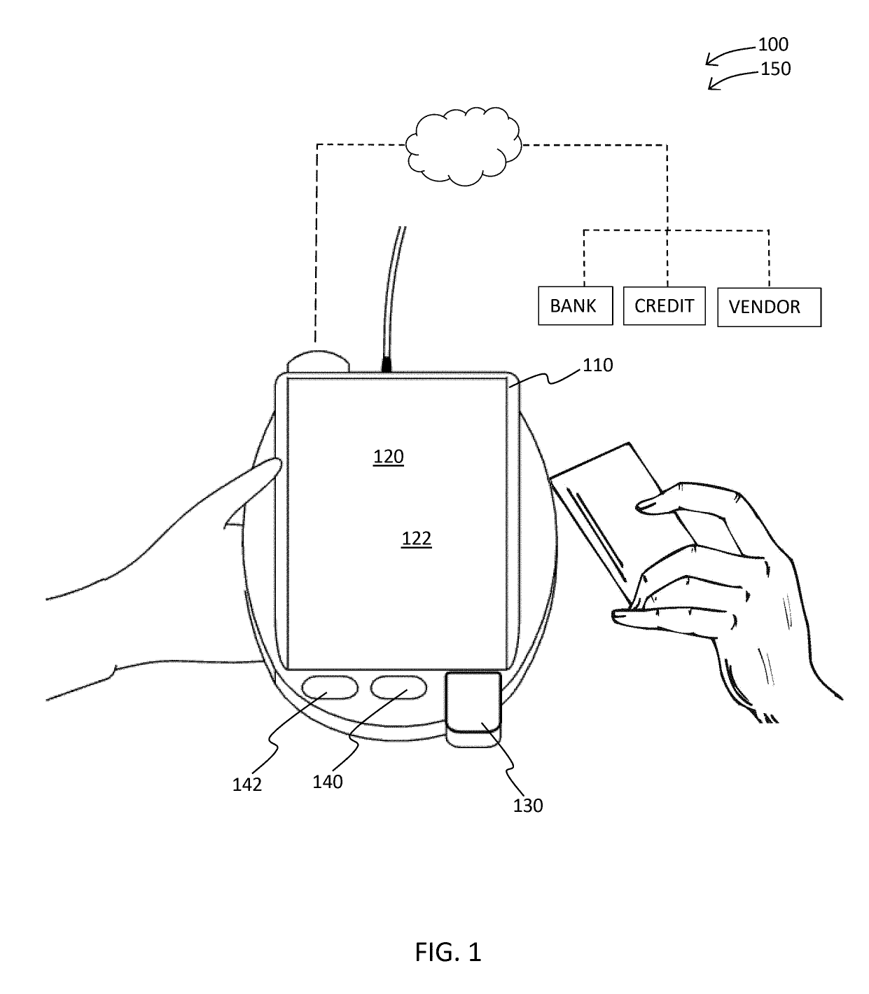

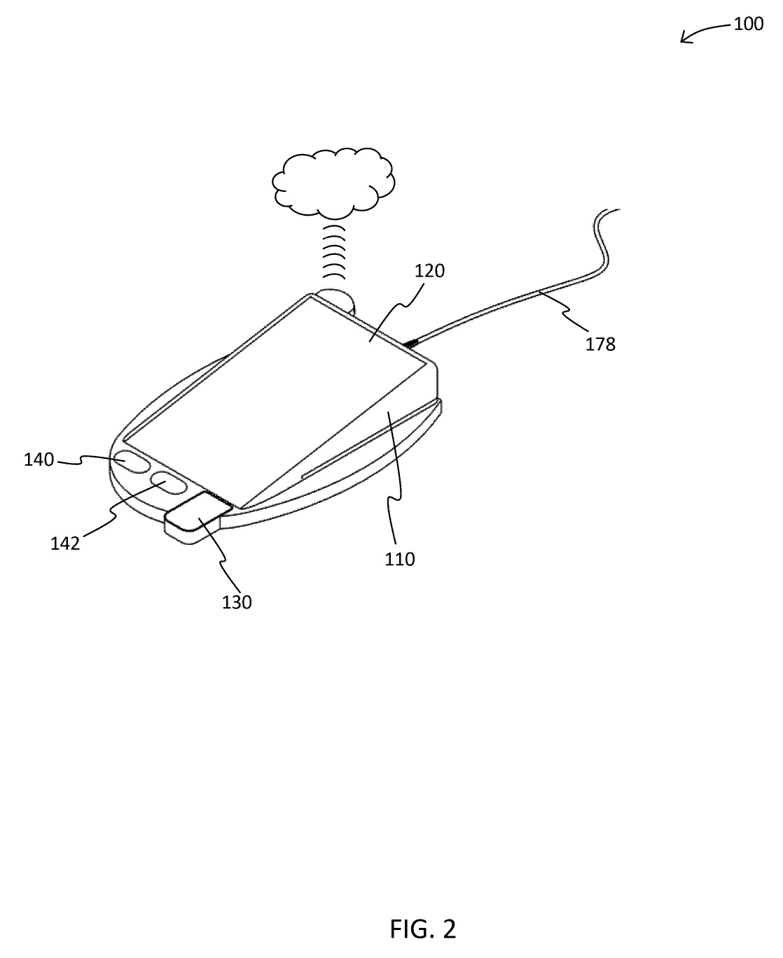

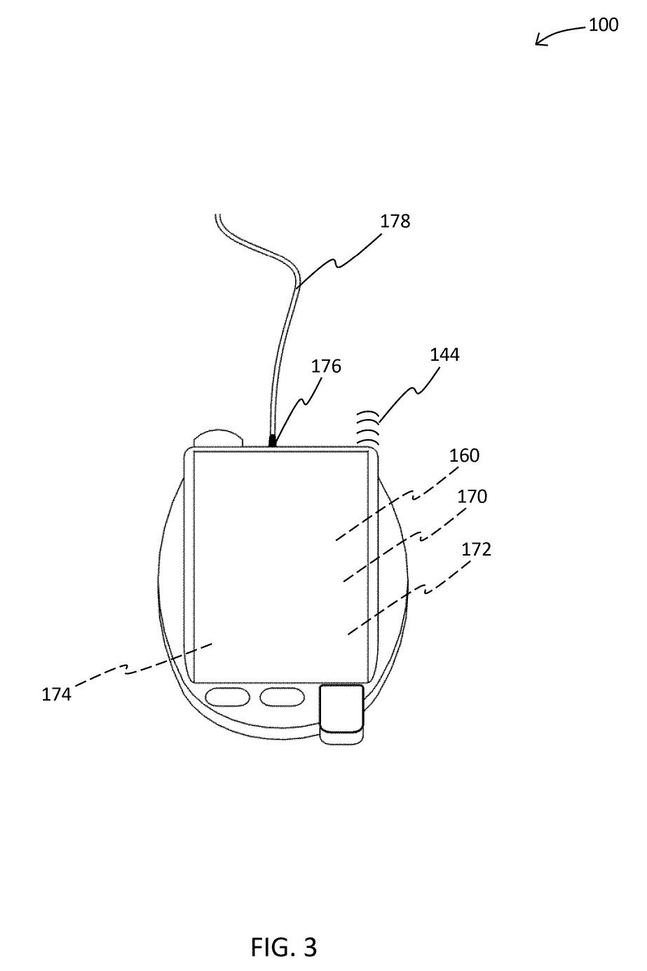

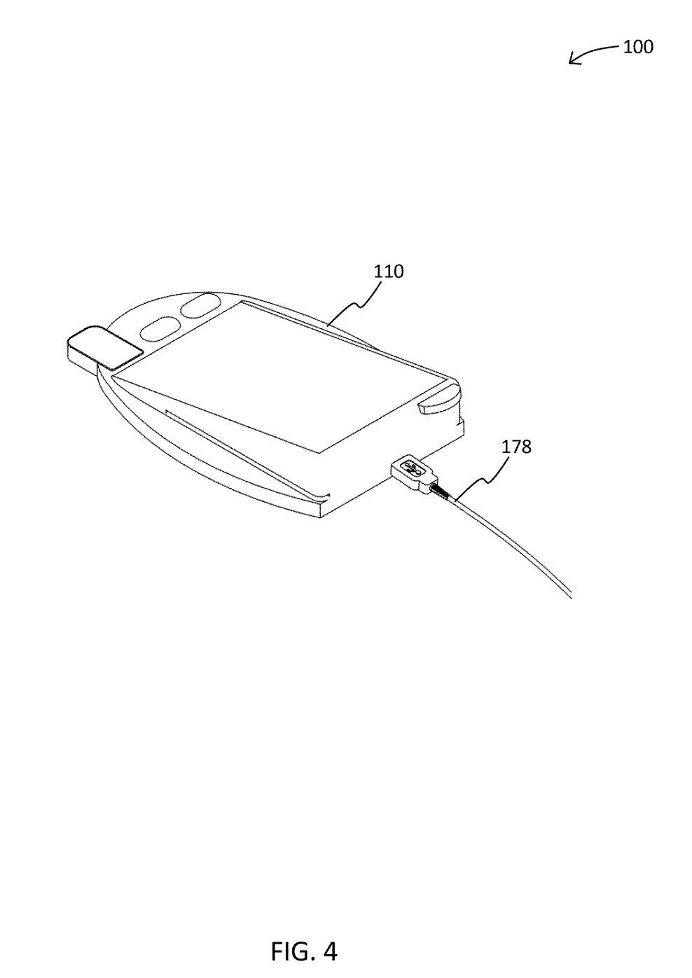

Referring now more specifically to the drawings by numerals of reference, there is shown in FIGS. 1-4, various views of a POS communication device 100. the POS communication device 100 comprising: a housing 110, a screen 120, a fingerprint scanner 130, at least one inputter 140, a microprocessor 160, a receiver 170, a transceiver 172, and a powerer 174; wherein the housing 110 is handheld (during in-use condition 150) and provides a mount for the screen 120, the fingerprint scanner 130, the at least one inputter 140, the microprocessor 160, the receiver 170, the transceiver 172, and the powerer 174; the screen 120, the fingerprint scanner 130, the inputter 140, the receiver 170, and the transceiver 172 in communication with the microprocessor 160 being powered by the powerer 174. Those with ordinary skill in the art will now appreciate that upon reading this specification and by their understanding the art of receivers and transceivers as described herein, methods of communication will be understood by those knowledgeable in such art.

The POS communication device 100 is able to be manipulated by an authorized-user to access financial information remotely; the receiver 170, and the transceiver 172 receiving and sending financial-data as pre-authorized by the authorized-user. As designed the POS communication device 100 provides real time authorization for financial charges relative to the financial information combined with fingerprint scanning technology via the fingerprint scanner 130 for rapid interactive tracking of the financial charges. The financial-data may be receivable from at least one banking institution, or from at least one credit card provider or the like. The authorized-user is able to access at least one debit-account and at least one credit-account.

Referring now to the fingerprint scanner 130; the fingerprint scanner 130 limits access to a ‘fingerprint-recognized’ authorized-user. The at least one inputter 140 comprises at least one button 142 (preferably two, red and green, but may be more or less may be used and different coloring, as desired). Red button when pressed may cancel a transaction for example and a press of green button may ‘ok’ the transaction. The at least one button 142 is able to allow access to the authorized-user provided a pre-authorized-code is entered correctly. Other inputting means may be used.

The POS communication device 100 further comprises at least one USB port 176; wherein the powerer 174 is able to be charged via a charge cable 178. The screen 120 is preferably a touch-screen 122. When the financial-data is received an audible alert or visual alert may be received via a speaker 144. The audible alert (sound, chime or the like indicating an occurrence is able to be delivered upon a transaction-use via the POS communication device 100. This may be from a vendor (store or the like), a bank or a credit card company (shown in FIG. 1) that an act of financial action is being performed. The transaction-use (occurrence) is remote from the POS communication device 100 (the user is not proximate the transaction-use when occurring or the alert may be shut off manually or via programming and use of GPS or the like). Those with ordinary skill in the art will now appreciate that upon reading this specification and by their understanding the art of proximity monitoring as described herein, methods of proximity indication and tracking will be understood by those knowledgeable in such art such that proximity monitoring is not exclusive to GPS. As such using the POS communication device 100 the transaction-use is able to be authorized or denied in realtime by allowing the authorized-user to input according to his/her wish when a notice comes though (received) and select ‘accept’ or ‘decline’. In this way the authorized-user is able to track purchases, debits, credits, get account balances as they occur to minimize chances of unauthorized use.

The POS communication device 100 may be arranged as a kit (for the system) as disclosed herein; wherein the system may have a set of user-instructions, a software application and various accessories.

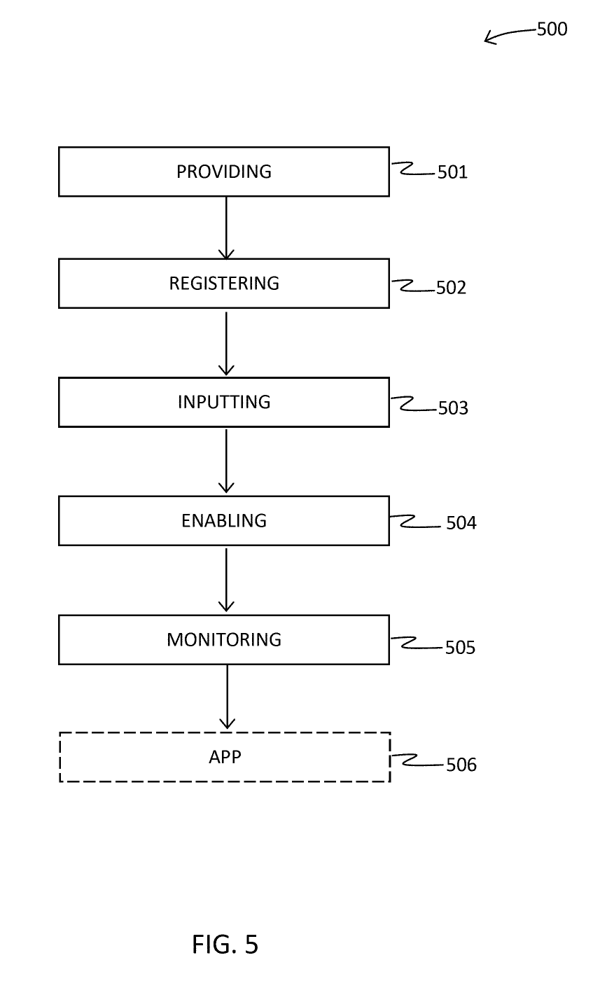

FIG. 5 is a flow diagram illustrating a method for using 500 the POS communication device 100, according to an embodiment of the present disclosure. In particular, the method of use 500 may include one or more components or features of the POS communication device 100 as described above. As illustrated, the method of use 500 for the POS communication device 100 may include the steps of: step one 501 providing a POS communication device, the POS communication device comprising: a housing, a screen, a fingerprint scanner, at least one inputter, a microprocessor, a receiver, a transceiver, and a powerer; step two 502 registering a fingerprint of an authorized-user; step three 503 inputting pre-authorized-code(s) to enable secure communication between the POS communication device and at least one financial institution and a plurality of user-selected vendors (as desired); step four 504 enabling financial-data alerts to be received when a transaction-use; and step five 505 remotely monitoring the transaction-use(s) in realtime. The method may further comprise the step six 506 of using the POS communication device in combination with a mobile application.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the POS communication device 100 are taught herein.

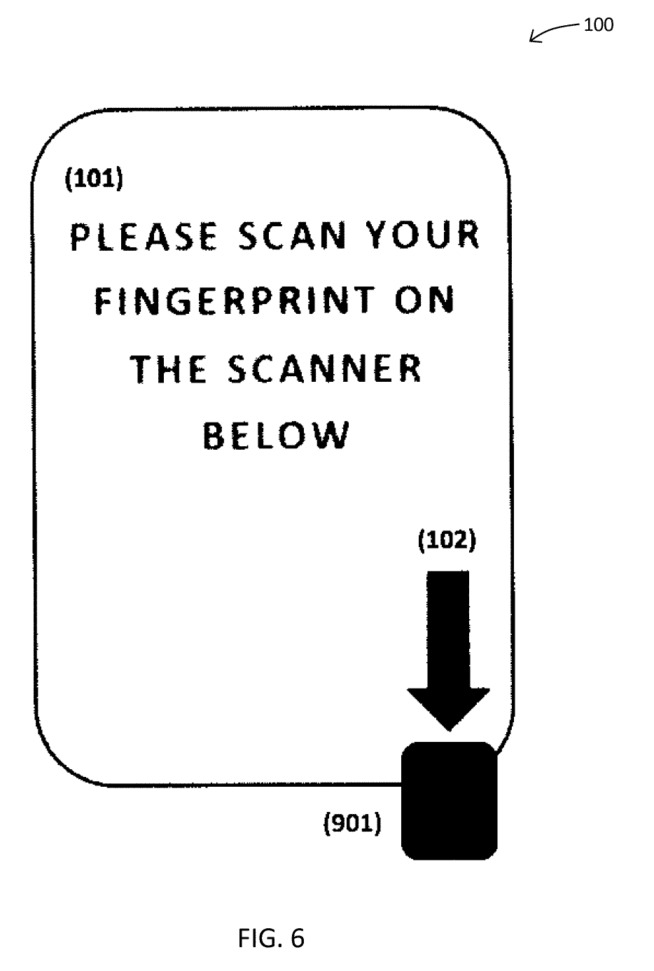

Referring now to FIGS. 6-15, FIG. 6 shows a screen view of the POS communication device 100 being used to direct a fingerprint to be scanned, according to an embodiment of the present disclosure. Once the user has indicated that he/she would like to pay by Thumb-I, the POS screen 101 will direct the user to use one of his/her registered fingerprints on the scanner attached to the unit. An arrow on the screen identifies the location of the fingerprint scanner 102. The customer will then hold their primary, registered fingerprint against the fingerprint scanner 901 and await a message. When the scan is successful a message in the centre of the screen will read ‘Scan successful. Please wait . . . ’ Should the initial scan fail, the user (customer) will read a message on the screen ‘Scan failed. Please try registered alternative print.’

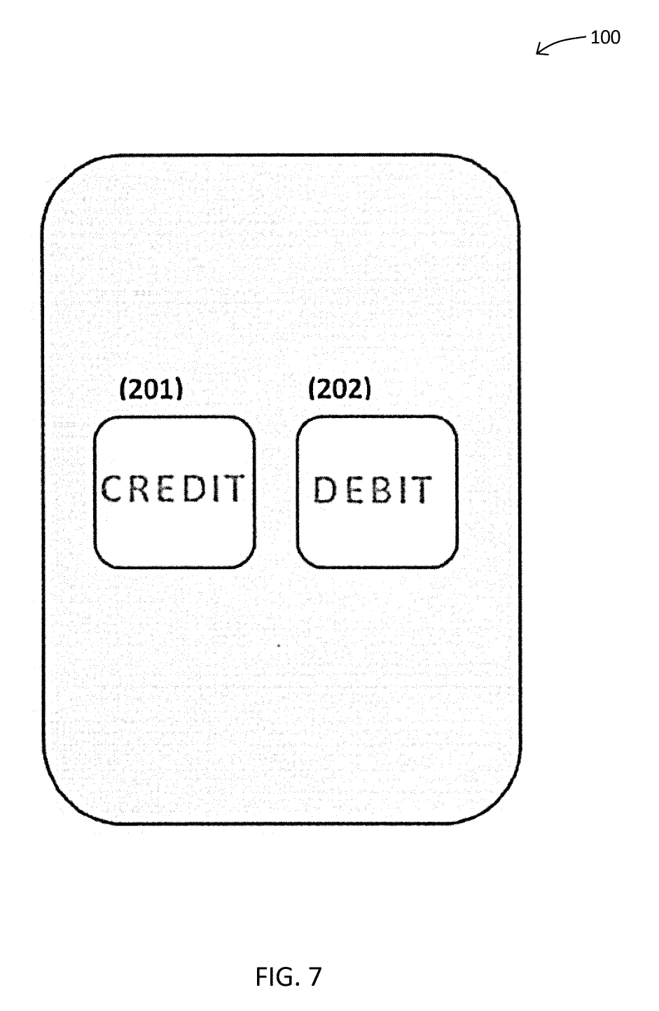

FIG. 7 shows a screen view of the POS communication device 100 once the fingerprint has been scanned, according to an embodiment of the present disclosure. Once the customer (user) has a successful print read the next screen will load to allow the customer to choose whether they will be using a credit account 201 or a debit account 202 using the touch screen. Now that the customer has successfully signed into their Thumb-I account, choosing 201 or 202 will bring up all of the corresponding payment methods which they have registered with their banks.

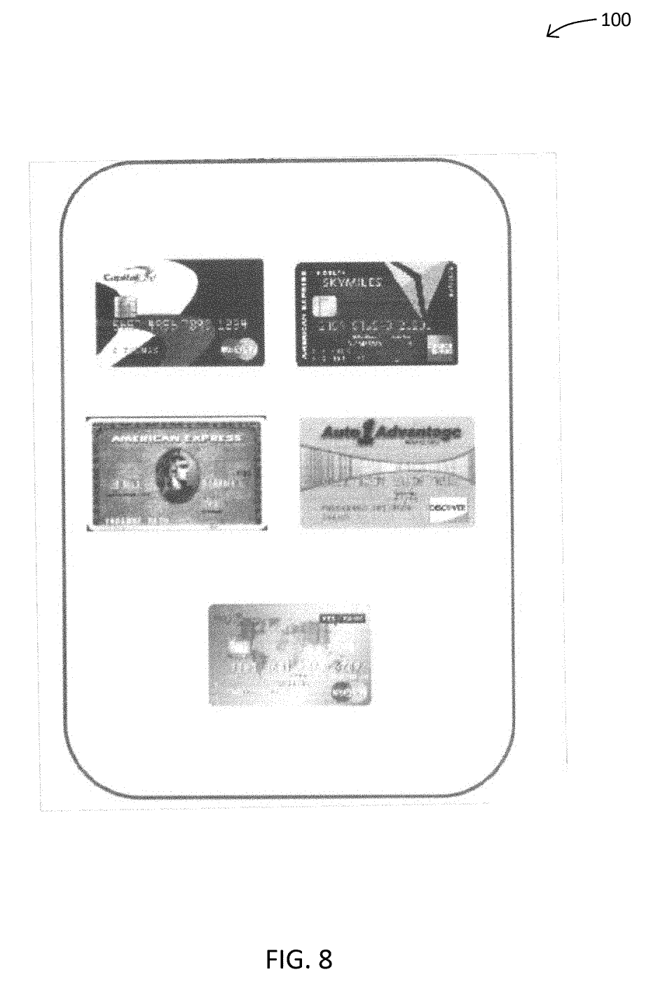

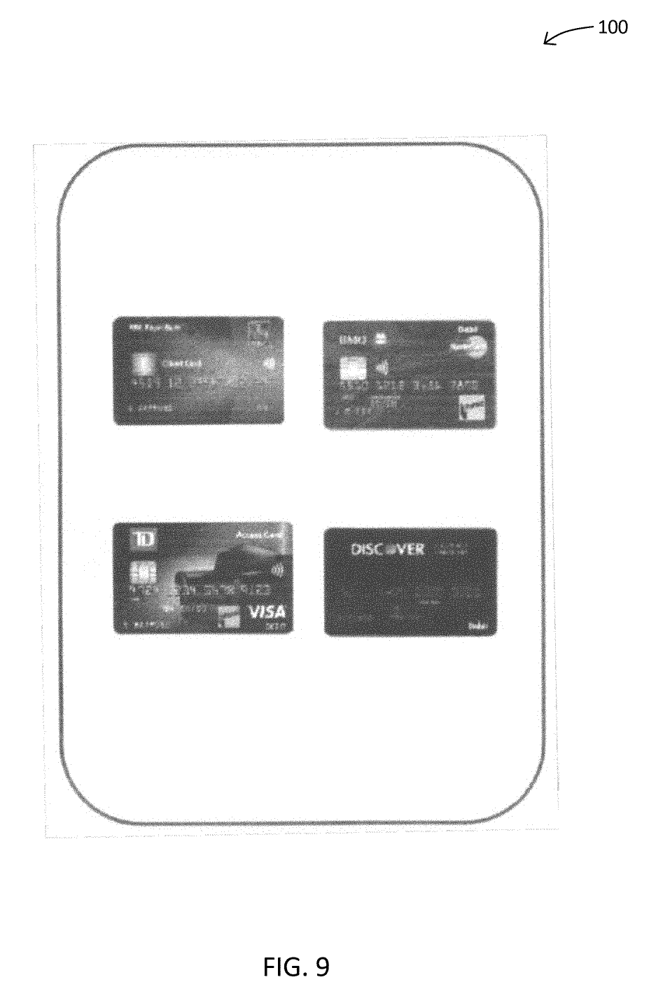

Referring now to FIG. 8 showing a screen view of the POS communication device 100 with an option to pay using a credit card, according to an embodiment of the present disclosure, the user is able to see the results of the customer's choice to pay with credit. This screen shows all of the credit cards that this customer has gone to the bank to register for Thumb-i. FIG. 9 shows a screen view of the POS communication device 100 with an option to pay using a debit card, according to an embodiment of the present disclosure, which depicts the results of the choice to pay with debit. All of these accounts have also been registered at the bank. Accounts may be added or removed from the program at any time by contacting the corresponding institution.

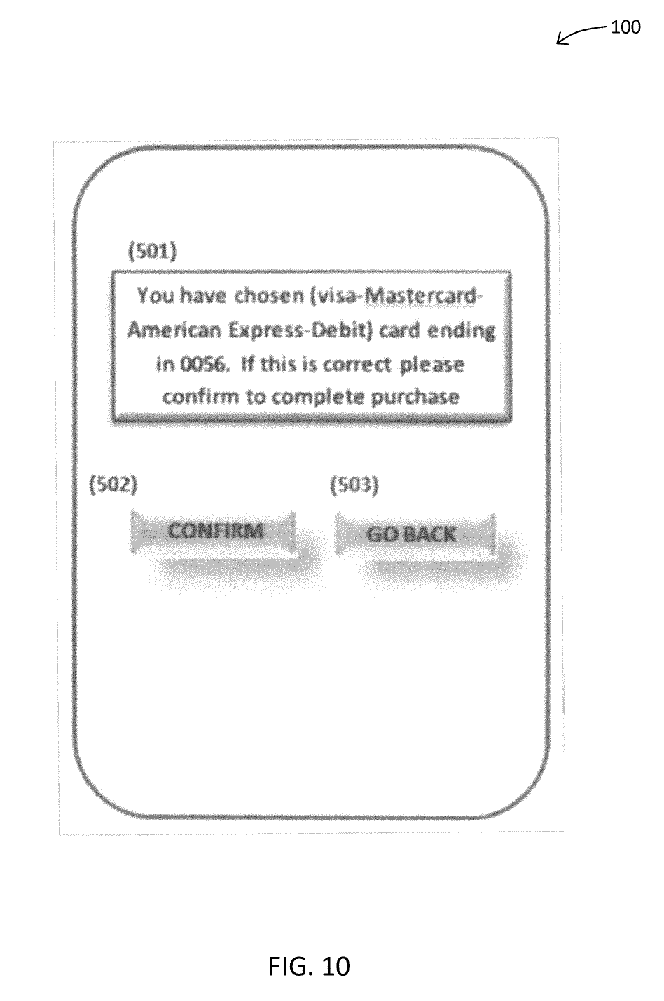

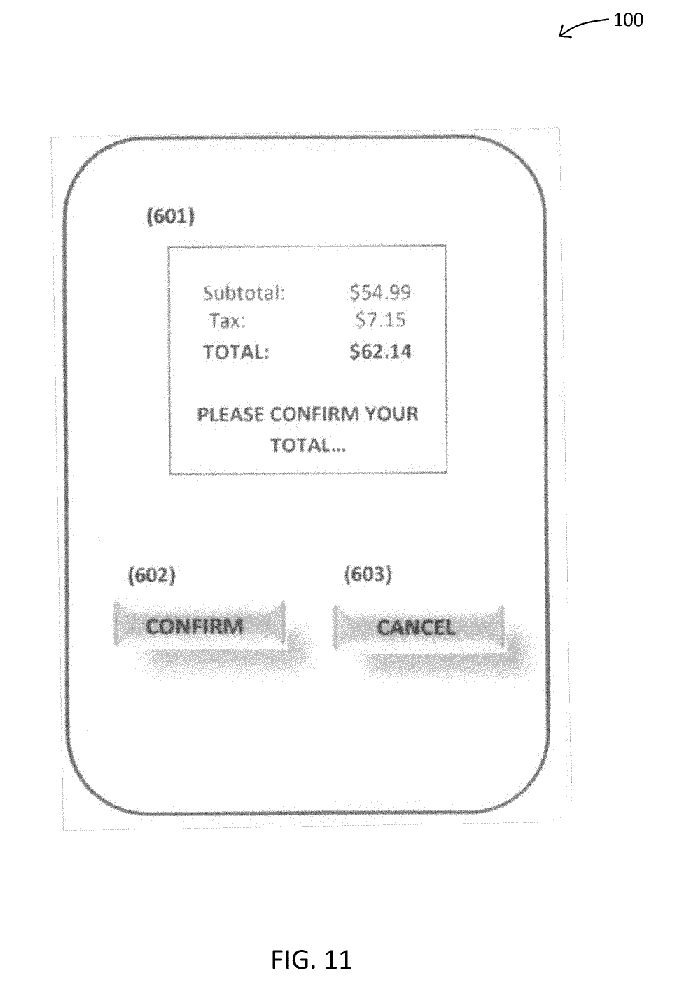

FIG. 10 shows a screen view of the POS communication device 100 once the preferred method of payment has been selected, according to an embodiment of the present disclosure. Once the customer (user) has chosen their preferred method of payment they will be prompted to confirm their choice 501. Should they confirm 502, the process will proceed to the next step (FIG. 11). If he/she would like to change the payment method listed in the confirmation, choosing the ‘go back’ option 503 will return them to the page where all registered cards are listed and he/she will be able to repeat the process from FIGS. 8 and 9.

FIG. 11 shows a screen view of the POS communication device 100 displaying a summary of the purchase, according to an embodiment of the present disclosure. As shown, the customer will see a summary of their total purchase 601 and have the option to confirm the total 602 or cancel their purchase 603. Should the user cancel at this point, for whatever reason, the transaction will cancel and he/she will need to start the POS process from the beginning.

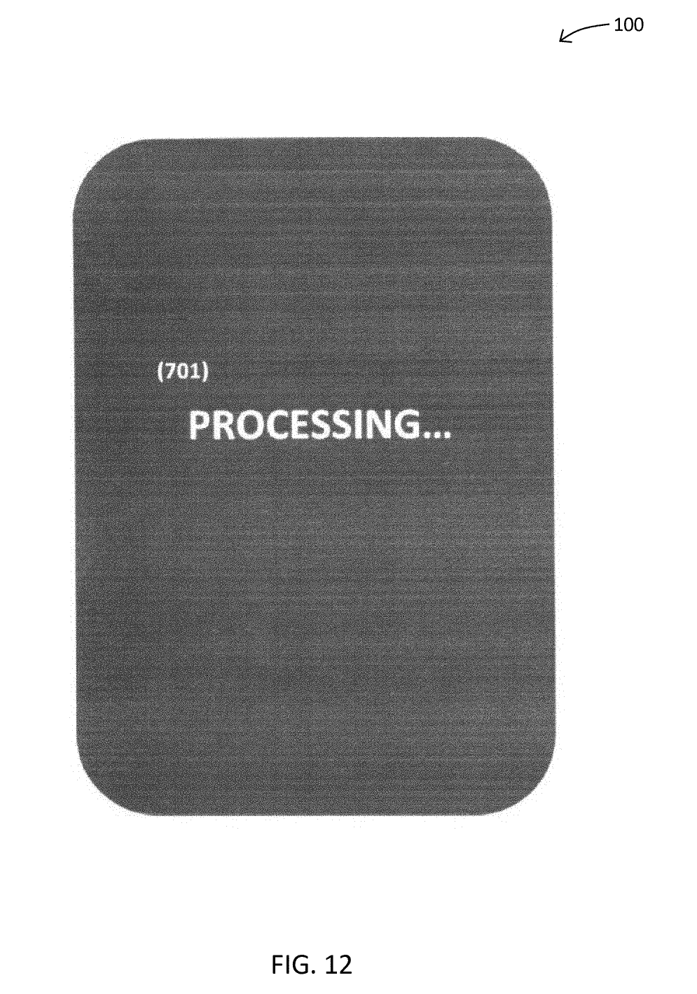

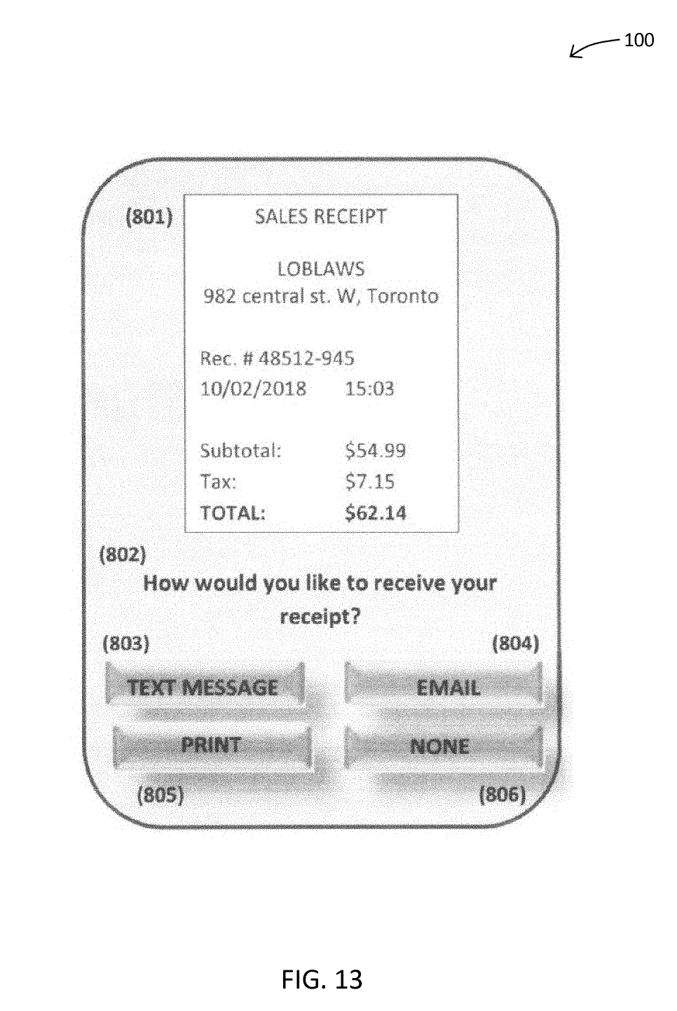

FIG. 12 shows a screen view of the POS communication device 100 displaying a processing message once the user has accepted the payment total, according to an embodiment of the present disclosure. FIG. 12 depicts the next step once the user has accepted the payment total. A message on screen will let the customer/user know that the payment method he/she has chosen is being processed for the total amount which they confirmed in previous steps. Once the payment is approved, the ‘PROCESSING’ message 701 will be replaced with a ‘PAYMENT APPROVED’ message and the process will move on to the next step (FIG. 13). If the payment is declined, the ‘processing’ message 701 will be replaced by ‘PAYMENT DECLINED.’ In this case, the transaction is cancelled and the customer will have to start the POS process over.

FIG. 13 shows a screen view of the POS communication device 100 displaying a receipt and options by which the user is able to get a physical or electronic receipt, according to an embodiment of the present disclosure. In this step, the customer (user) will choose how he/she wants to receive his/her receipt. The main image 801 gives the customer a brief overview of his/her receipt while choosing an email 804 or print 805 copy will give you the full, detailed version. A text message receipt will provide the customer with the store name, location, total and time of purchase along with a reference number. All receipts, even if they choose not to receive one, will be saved to the Thumb-I profile and available when he/she logs into the account through the app or online.

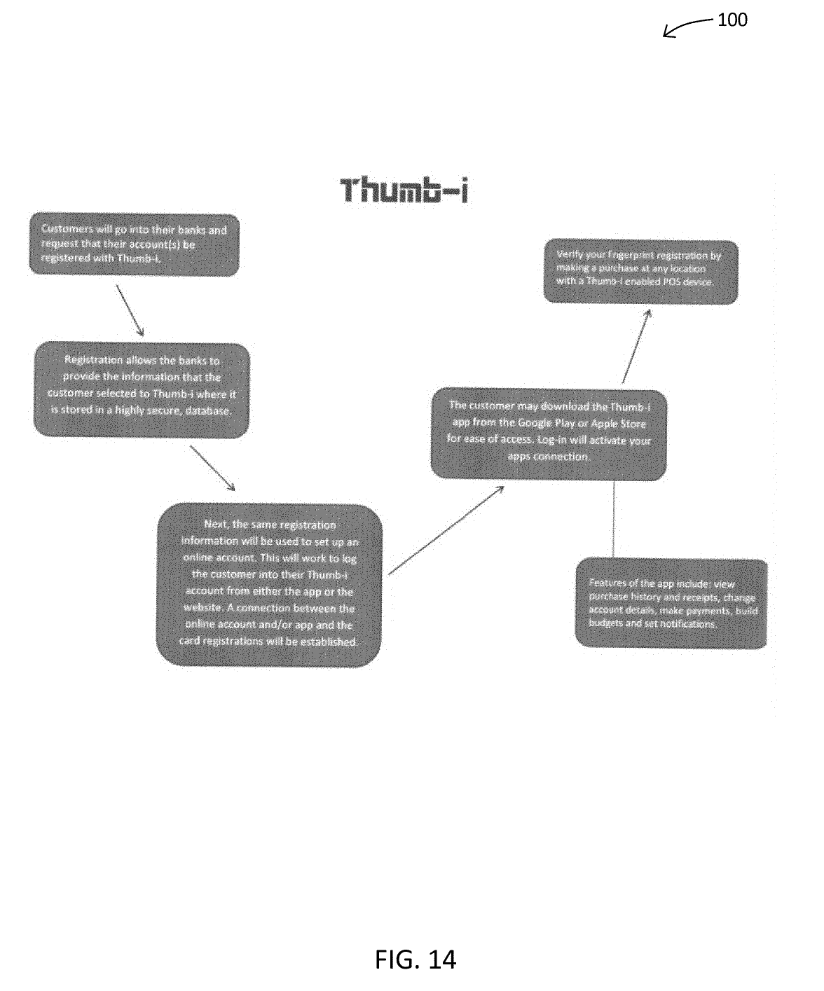

FIG. 14 shows another flow diagram for the POS communication device 100, with details of Thumb-I, according to an embodiment of the present disclosure. Customers will go into his/her bank(s) and request that their account(s) be registered with Thumb-I. Next, registration allows the banks to provide the information that the customer selected to Thumb-I where it is stored in a highly secure, database. Next, the same registration information will be used to set up an online account. This will work to log the customer into their Thumb-I account from either the app or the website. A connection between the online account and/or app and the card registrations will be established. The customer may download the Thumb-I app from the Google Play or Apple Store for ease of access. Log-in will activate the user's apps connection. Next, the fingerprint registration can be verified by making a purchase at any location with a Thumb-I enabled POS device. Features of the app include at least: view purchase history and receipts, change account details, make payments, build budgets and set notifications.

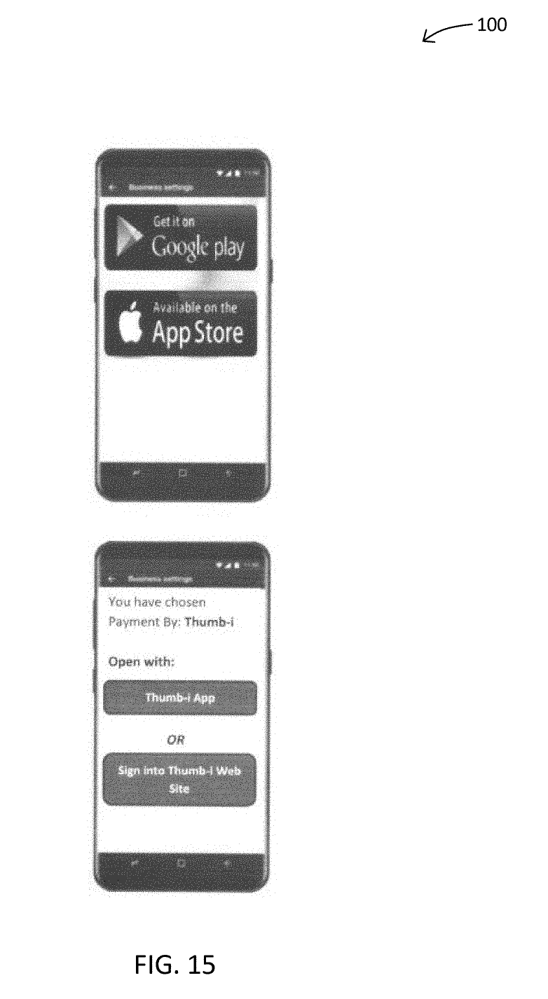

FIG. 15 shows a flow diagram for the app used with the POS communication device 100, according to an embodiment of the present disclosure. Thumb-I App flow chart comprises: (1) Customer downloads Thumb-I App from APPLE STORE or GOOGLE play. (2) The customer will create a profile on the Thumb-I App which will include scanning his/her fingerprints for secure verification and authorization. This will allow the customer to access all of their registered credit and debit cards. (3) Within the app, customers will have the options to view purchase history and receipts, change account details, build budgets and set notifications. (4) Online vendors with the Thumb-I payment option allows customers the option to go through the app to make payments. (5) If the client chooses to pay through the Thumb-I app, the app will open and require authentication (by the smartphone's fingerprint sensor). At this point, the customer may choose which of their registered payment methods they would like to use to make this purchase. He/she will verify his/her choice as well as the purchase total and then payment will be processed. All payment history is available for review immediately on the app. (6) All capabilities of the app—mentioned above, are also available on the online website. In this case the customer will access their account with their secure log in details as opposed to the thumbprint used to access the account through the app.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A POS communication device, the POS communication device comprising:
a housing;
a screen;
a fingerprint scanner;
at least one inputter;
a microprocessor;
a receiver;
a transceiver; and
a powerer;
wherein said housing is handheld and provides a mount for said screen, said fingerprint scanner, said at least one inputter, said microprocessor, said receiver; said transceiver, and said powerer, said screen, said fingerprint scanner, said inputter, said receiver; and said transceiver in communication with said microprocessor being powered by said powerer;
wherein said POS communication device is able to be manipulated by an authorized-user to access financial information remotely, said receiver, and said transceiver receiving and sending financial-data as pre-authorized by said authorized-user; and
wherein said POS communication device provides real time authorization for financial charges relative to said financial information combined with fingerprint scanning technology via said fingerprint scanner for rapid interactive tracking of said financial charges.

2. The POS communication device of claim 1, wherein said financial-data is receivable from at least one banking institution.

3. The POS communication device of claim 1, wherein said financial-data is receivable from at least one credit card provider.

4. The POS communication device of claim 1, wherein said fingerprint scanner limits access to a fingerprint-recognized said authorized-user.

5. The POS communication device of claim 1, wherein the at least one inputter comprises at least one button.

6. The POS communication device of claim 1, further comprising at least one USB port.

7. The POS communication device of claim 1, wherein the powerer is able to be charged via a charge cable.

8. The POS communication device of claim 2, wherein the authorized-user is able to access at least one debit-account.

9. The POS communication device of claim 2, wherein the authorized-user is able to access at least one credit-account.

10. The POS communication device of claim 1, wherein the screen is a touch-screen.

11. The POS communication device of claim 3, wherein said financial-data is received in combination with an audible alert via a speaker.

12. The POS communication device of claim 11, wherein the audible alert is delivered upon a transaction-use.

13. The POS communication device of claim 12, wherein the transaction-use is remote from the POS communication device.

14. The POS communication device of claim 1, wherein the at least one button is able to allow access to said authorized-user provided a pre-authorized-code is entered correctly.

15. The POS communication device of claim 13, wherein the transaction-use is able to be authorized in realtime.

16. The POS communication device of claim 13, wherein the transaction-use is able to be denied in realtime.

17. A POS communication device, the POS communication device comprising:
a housing;
a screen;
a fingerprint scanner;
at least one inputter;
a microprocessor;
a receiver;
a transceiver;
at least one USB port;
a speaker; and
a powerer;
wherein said housing is handheld and provides a mount for said screen, said fingerprint scanner, said at least one inputter, said microprocessor, said receiver; said transceiver, said a speaker, and said powerer, said screen, said fingerprint scanner, said inputter, said receiver; and said transceiver in communication with said microprocessor being powered by said powerer,
wherein the powerer is able to be charged via a charge cable;
wherein said POS communication device is able to be manipulated by an authorized-user to access financial information remotely, said receiver, and said transceiver receiving and sending financial-data as pre-authorized by said authorized-user;
wherein said financial-data is receivable from at least one financial institution;
wherein said fingerprint scanner limits access to a fingerprint-recognized said authorized-user;
wherein the at least one inputter comprises two buttons;
wherein the two buttons are able to allow access to said authorized-user provided a pre-authorized-code is entered correctly;
wherein the authorized-user is able to access at least one debit-account and at least one credit-account;
wherein the screen is a touch-screen;
wherein said financial-data is received in combination with an audible alert delivered via said speaker;
wherein the audible alert is delivered upon a transaction-use at a vendor;
wherein the transaction-use is remote from the POS communication device; and
wherein the transaction-use is able to be authorized and alternately denied in realtime.

18. The POS communication device of claim 17, further comprising set of instructions; and a mobile application;
wherein the POS communication device is arranged as a kit.

19. A method for using a POS communication device, the method comprising the steps of:
providing a POS communication device, the POS communication device comprising:
a housing;
a screen;
a fingerprint scanner;
at least one inputter;
a microprocessor;
a receiver;
a transceiver; and
a powerer;
registering a fingerprint of an authorized-user;
inputting pre-authorized-code(s) to enable secure communication between said POS communication device and at least one financial institution and a plurality of user-selected vendors;
enabling financial-data alerts to be received when a transaction-use occurs; and
remotely monitoring said transaction-use(s) in realtime.

20. The method of claim 19, further comprising the step of using said POS communication device in combination with a mobile application.
